(19) United States
(12) Patent Application Publication
(10) Pub. No.: US 2005/0255201 A1
(43) Pub. Date: Nov. 17, 2005

(54) Reservoir used with container for combination food

(75) Inventors: Thomas L. Gruhot, Marshall, MN (US); Bret T. Jenkin, Marshall, MN (US); Mark W. Radke, Cottonwood, MN (US)

Correspondence Address: MERCHANT & GOULD PC, P.O. BOX 2903, MINNEAPOLIS, MN, 55402-0903, US

(73) Assignee: Schwan's Food Manufacturing, Inc.

(21) Appl. No.: 10/843,074

(22) Filed: May 11, 2004

(51) Int. Cl. A23B 4/00

(52) U.S. Cl. 426/115

(57) ABSTRACT

A food preparation system can comprise a sealed reservoir mated to a container. The sealed reservoir contains a food product. The sealed reservoir can be opened for ease of use. In use, the sealed reservoir is opened, its contents dispensed into the empty container and the empty container is filled with a liquid food to make a consumable combination food product. Preferred systems include systems for preparing ice cream carbonated beverage floats, cold cereals, hot cereals, soups, stews and other foods.

### FIELD OF THE INVENTION

The invention relates to a reservoir that can contain a food. The invention also relates to a food preparation system using a container that can be filled from a mated reservoir filled with a food. Such a system can be used to prepare a large variety of foods in an efficient and cost-effective manner. The reservoir is adapted for easy and efficient transfer of the food from the reservoir into a container. The food can then be combined in the container with a second food to form a consumable combination food. Typically the container is empty when mated with the reservoir. The combination food of the invention can involve the preparation of a combination food in which a solid, semisolid or substantially solid food is transferred from the reservoir into the container and a second food is added to a solid food in the container to produce a combination food.

### BACKGROUND OF THE INVENTION

Disposable containers for food products have become more and more common. Often dry soups, desserts, yogurts, etc. are prepackaged in disposable plastic containers. In use, a removable closure in the form of a paper, film or foil is used to enclose the food in the container. In use the container can be opened, some optional preparation can occur and the food is then consumed. In one example, in the preparation of soup from dry soup, a lid is removed and hot water is introduced to form a final soup or like product. The packages are typically one-part packages with a single opening that is closed with a removable, flexible seal.

Other packaging containers similarly comprise a single container with a filling that can be consumed immediately or combined with other products. Similar embodiments are shown in, for example, Hanley, U.S. Pat. No. 4,285,490 involving a cup containing a preformed ice cream part. In use, the Hanley container is opened, the ice cream is released from its internal container and the container is then filled with a carbonated beverage. Blow, Jr. et al., U.S. Pat. No. 4,054,205 show a cup shaped vessel that is fitted to a beverage can. The container is designed to enable the consumer to add the beverage into the container for ease of consumption. Blow, Jr. et al. indicate that the container can be filled with food that can be consumed prior to consumption of the beverage. The material in Blow, Jr. et al. is not added to the beverage. Lastly, Slangan et al., U.S. Pat. No. 4,233,325 show an ice cream sundae making system having the ice cream in a container combined with a second container having heatable syrup or topping.

The prior art shows relatively simple systems for packaging foods. In the need for increased flexibility of food products, a substantial need has existed for the ability to package a typically solid, semisolid or substantially solid food and conveniently combine it with a second food in a container to form a final combination food or combined food product. Such combination foods typically comprise, for example, a combination of a beverage and ice cream, a combination of a dairy product and breakfast cereal, a combination of heated water and a solid coffee beverage mix, a combination of heated water and an oatmeal or other such breakfast preparation, and other materials that require a combination of a solid food and a second food source that can be mixed in a container to prepare a combination food. Such combination foods can also comprise combination of two substantially solid foods such as ice cream or topping and a bakery product, yogurt and cereal, etc.

Such combination foods require an easy, convenient system that can be quickly assembled and then used to serve the food immediately without delay. The convenience of the system is important in today's environment. A substantial need exists for food systems that can obtain a rapid preparation of the food and convenient food consumption.

### BRIEF DESCRIPTION OF THE INVENTION

The invention relates to a unique reservoir shape adapted for transferring a first food into a container. The reservoir has an overall shape adapted to the first food stored within the reservoir. The reservoir can be substantially cylindrical, oval, square, triangular or other geometric shape. A cylindrical reservoir can often be used with frozen materials such as ice cream or frozen entrees. A triangular reservoir can often be used with pies or other desserts. An oval reservoir can be used with salads, finger food, etc. The reservoir is adapted for mechanical joining or mating with the container. The reservoir is sized to contain an amount of food appropriate for the container. The reservoir is structured such that it can be easily opened and the food transferred to the container. A preferred embodiment, a substantially shaped reservoir, adapted to a combination food, is formed having a side wall and substantially opposite ends. Each end comprises an easy opening mechanism that permits rapid transfer of the food to a container. The invention also relates to a food preparation system that can be used to form a combination food in a container by first transferring a first food into the container and then combining the first food with a second food. The system comprises a reservoir containing a food that can be mated to a container with mating means or a mating surface. The food in the reservoir can be transferred to a container and combined with a second food to make a combination food product. The term combination food product is intended to encompass a food that is typically prepared by contacting a first food with a second food. In the practice of the invention, a first food is added to the container followed by the addition of a second food. The first and second foods are then combined in the container. The first and second foods can be mixed if needed, however, some foods require no mixing. The first and second foods can be low viscosity liquids, high viscosity liquids, semisolids, substantially solid materials or solid materials. The term solid foods include particulate foods such as dry soup mixes, dry cereals, freeze-dried (lyophilized) trail foods and other such particulate.

In a preferred embodiment, the reservoir comprises an openable enclosure for the first food with at least two openable surfaces. In one aspect the enclosure has a substantially shaped wall or tapered form and on each end of the cylinder a means to open the reservoir. In application, the reservoir has a joining or mating means or a joining or mating surface that can match a cooperative joint or surface in the container. The container-mating surface having a means to open the reservoir is opened and mated to the container. The second end of the substantially cylindrical reservoir having a second opening means is then opened and the contents of the reservoir can then be fully transferred to the container. Foods that resist transfer such as solids, frozen foods, high viscosity foods, etc., can be cleared from the reservoir using the second opening aided by mechanical transfer means such as a spatula, spoon, fingers or other such tool. The reservoir can either be left in place or removed and a second food can then be added to the container to form the combination product.

In one preferred embodiment of the invention, the food transferred is a solid food and the food product added to the container comprises a liquid, semisolid or solid food. In another preferred embodiment, the food transferred is a semisolid or particulate food and the second food product added to the container comprises a second semisolid food. In another embodiment, the first food comprises a frozen food and a second food comprises a liquid food. The reservoir can have specialized opening means for use with the various types of food products. A reservoir adapted for a particulate food can have a enclosure adapted for particular transfer while a reservoir adapted for a liquid food can have a simple puncturable enclosure adapted to the transfer of the liquid food. The reservoir can have mating means to secure the reservoir to the container for food preparation.

An aspect of the invention is a reservoir adapted for use with a container for making a combination food. The reservoir typically comprises a container having a mating surface that can obtain a stable connection to the container. The reservoir comprises an enclosure with typically opposing openable surfaces. The openable surfaces comprise means to open the reservoir to promote transfer of the food from the reservoir to the container. In another aspect of the invention, the reservoir enclosure is equipped with a score line and pull-tab structured at one surface. A film, paper or foil adhered to an opening for ease of removal can also be used to seal the enclosure. In one embodiment of the invention, the substantially cylindrical reservoir can have a score line and pull tab structure at one end of the reservoir and an adhered film, foil or paper enclosure at the opposite end. In another aspect, the reservoir comprises a cylinder or other substantially cylindrical body that can be stepped or tapered. The reservoir is typically filled with a first typically solid food. For the purpose of this disclosure, the term “solid” means that the material cannot flow as a liquid with in a relatively short preparation period of time (i.e.) less than 180 seconds. Solids, for the purpose of this disclosure, include frozen materials such as ice cream and other low temperature solids, breakfast cereal, oatmeal mix and other materials that are typically in a solid or solid particulate form. A solid food can also include a particulate food such as a dry mix, a freeze-dried food, a breakfast cereal, a hot cereal mix or other such particulate. Another aspect of the invention is a combination of the reservoir with a container. Typically, the container is empty and is sized and configured to receive the food from the reservoir for later combination with a second food to form the combination food. Still another aspect of the invention is the method for forming a combination food. In the method, a reservoir having a food is opened and mated to the container. A second opening of the reservoir is removed permitting complete transfer of the food from the reservoir into the container. The food in the reservoir is combined with a second food to form a combination food. Optionally, the reservoir can be removed after transfer, if necessary. For the purpose of this disclosure, the term “food” includes any liquid, to make solid, substantially solid or solid substance that can be safely ingested by individuals. Such materials include foods certified by the U.S. Department of Agriculture or the Food and Drug Administration, potable water, and other liquid or solid food materials commonly available in retail establishments or available for use in the home.

### BRIEF DESCRIPTION OF THE DRAWINGS

FIG. 1 is a view of one embodiment of the invention in a generally cylindrical container having a lower container portion with the upper-mated reservoir adapted to transfer the food from the reservoir to the container.

FIG. 2 is a view of the opposed sealing means on the openable ends of the reservoir.

FIG. 3 is a view of the pull tab/score line sealing means at one axial end of the reservoir.

FIG. 4 is a cross-section of the system showing in phantom, the position of the contents prior to dispensing into the container and the location of the contents in phantom after dispensing.

FIG. 5 is a view of the pull ring/score line opening means of the reservoir.

FIG. 6 is a cross section of the mating surface of the reservoir of the invention.

FIG. 7-9 are views of one embodiment of the invention that can be used to combine a stored food with a freshly made products to make a combination food.

FIGS. 10-13 are views of a second embodiment of the invention having a reservoir with a friction fit or press fit closure in combination with an adhered film, foil or paper closure on opposing openable ends of the reservoir.

### DETAILED DESCRIPTION OF THE INVENTION

As discussed above, the invention is embodied in a reservoir that can be mated with a container for the purpose of transferring a food from the reservoir to the container to make a combination food in the container.

### Food

The structures and methods of the invention relate to the manufacture of a combination of food. A combination food, for the purpose of this disclosure, typically comprises a combination of a liquid food with a solid food or the combination of two solid foods.

Liquid foods typically comprise any flowable material that can be safely consumed by humans and includes potable water, dairy products such as milk, cream, artificial liquid, cream or products, yogurt, beverages such as coffee or tea, carbonated beverages, syrups, salsa, ketchup, mustard, flowable cheese products, sauces, gravies, and other flowable foods with a measurable liquid viscosity that can be delivered into the container for the purpose of forming the combination food. The minimal requirement for the liquid food of the invention includes safety for the consumer, straightforward introduction into the container and a satisfactory match of flavors between the liquid food and the solid food.

The liquid food added to the container is typically supplied by the consumer and is not typically stored in the container, however, in one embodiment of the invention, the container can be filled or partially filled with the liquid food prior to the addition of the food from the reservoir. In the embodiment that includes an ice cream float, hot cereal, soups, stews, etc., the container is typically empty, initially. Once the (e.g.) ice cream is transferred from the reservoir into the container, the container and ice cream can be combined with a carbonated beverage to substantially fill the container resulting in the ice cream float product. In the instance that the liquid food comprises a yogurt and the solid food from the reservoir comprises a mueslix or other breakfast food product, the container can contain an initial charge of the yogurt comprising a partial or full charge of the material into the container prior to the addition of the particulate food, recognizing that the container cannot be overly filled with the yogurt prior to combination with the particulate breakfast food. Liquid foods include water, milk, coffee, tea, carbonated beverage, vegetable or fruit juices, juice concentrate, soup, alcoholic beverages, and other adjustable liquids. Liquid foods can also include higher viscosity but flowable foods such as cream, sour cream, creamers, syrups, gravy, hot fudge, caramel toppings, butterscotch toppings, molasses, butter flavors, flowable margarine, salsa, ketchup, mustard, horseradish, guacamole, hollandaise, and other flowable sauces or similar preparations.

Substantially solid foods that can be introduced into the reservoir include solid foods such as ice cream, low fat desserts, breakfast cereals, dried oatmeal or dried cream of wheat products, dried or frozen foods that can be reconstituted with hot water or other liquids, chicken wings, Brownies, pie, cookies, salad preparations, potato preparations including mashed potatoes, french fries, potato buds, popcorn, crackers, pasta such as a spaghetti, linguini, rigatoni, elbow macaroni, including a large variety of pasta shapes and sizes.

The reservoir and container of the invention are typically sized for single, dual or more serving portions of the combination food. One important embodiment is the use of the reservoir of the invention in a single serving configuration. Such single serving configurations are useful for applications in a quick service restaurant environment (Subway, Burger King, or McDonald's), or a convenience store setting (Circle K, 7-Eleven, or SuperAmerica stores), or other retail stores adapted for quick and easy food preparation. It can be for either immediate, on-site consumption or consumed later in the home. In certain circumstances, however, it may be efficient or desirable to configure the reservoir or the container, or both, for two, three or more multiple serving portions that can satisfy two, three, four or more individuals with the contents of the container. In the instance that the container is used to make a breakfast food, the portions can be relatively large in proportion to, for example, a snack portion. In the instance that the container is used to make a dinner or supper portion, the proportions used in the container can be relatively larger than the breakfast proportions. The container can be sized and configured to enclose an amount that ranges from about 20 to 100 milliliters of volume through a volume that can reach as much as 1-5 liters. Such a large volume can obviously provide sufficient amounts of food for multiple individuals. Single serving containers can comprise a volume that ranges from about 100 milliliters to 1 liter. In the practice of the invention, typically the container and the reservoir have means permitting the secure mating of the container and the reservoir. In a preferred mode, the container is typically empty prior to introduction of any food material. The container is typically disposable, but with a configuration that lends itself to ease of preparation and consumption of the combination of food. In large part the container will match the overall shape of the reservoir as discussed above. In order to make the reservoir join to the container, at a minimum, the mating or joining surfaces of the reservoir must match the mating or joining surfaces of the container. A preferred embodiment of the container is a substantially upright cylindrical container, that matches the substantially cylindrical reservoir, the container having an upwardly facing opening. The cylindrical container can be tapered from the upwardly facing opening to the base of the container. The mating surface of the container adapted to the mating surface of the reservoir typically comprises a mechanically stable lip or other structure of the container that can be securely mated to a complementary surface on the reservoir. In a preferred mode, the container typically comprises a cup-like structure having a volume from about 50 milliliters to 900 milliliters made from a disposable thermoplastic composition formed into a useful container shape or configuration. The reservoir is mated to an empty container having a volume of at least 250 milliliters. In use, the reservoir is opened at both axial ends, is mated with the empty container and the food product is dispensed into the cup. Once in the cup, the food product is then combined with a liquid food to make a final consumable material. In a preferred mode, both the reservoir and container are substantially cylindrical, but can take the form of tapered cylinders. The reservoir is sealed with axial seals at opposite ends of the cylindrical reservoir. In use, both seals are removed prior to dispensing the food into the container.

A number of combination foods have been identified. Such combination foods include a first solid food in a top reservoir cup combined with a second solid food in the container. Alternatively, a first solid food can be stored in the reservoir and combined with a liquid in the container. In another alternative, a first viscous or semisolid food in the reservoir cup can be combined with a liquid in the container. In a final embodiment, a semisolid liquid or viscous first food can be placed in the reservoir for combination with a solid food in the container. These embodiments are exemplified as follows:

Solid Food in Reservoir Over Solid Food in the Container

This embodiment can include dry spice blend on chicken wings, brownie over ice cream (apply microwave heat to brownie), ice cream toppings (chocolate, fudge, caramel apply microwave heat), cookies on ice cream, ice cream over cake pie over ice cream (apply microwave heat to pie), ice cream over pie dry salad toppings on salads, potato toppings on potatoes (cheese sauce with bacon bits-apply microwave heat), various seasonings on popcorn, cheese, viscous sauce and seasoning blend over pasta (apply microwave heat), candies on popcorn (m & m's, peanut butter and chocolate) and sweet or savory seasonings on crackers.

Solid Food in Reservoir Over Liquid in Container

This embodiment can include ice cream over soda (or carbonated beverages (ice cream float)), ice cream over non-carbonated beverages, chips/crackers over soup, flavored, frozen juice/juice drink concentrate, powdered drink mix over water, frozen alcoholic and non-alcoholic drink mixes, carbonated tablets that fizz, change colors and flavor water for kids, soup bouillon cubes and frozen soup mix to water

Liquid/Viscous in Top Reservoir Cup Over Liquid in Bottom Cup

This embodiment can include coffee flavorings and creamers over coffee, flavored syrups over milk, flavored syrups over carbonated or non-carbonated beverages, shelf stable concentrated coffees and teas over hot water, shelf stable concentrated juices and juice drinks over cold water, shelf stable concentrated energy drinks, herbal supplements, tonics and elixirs, variety of liquid herbs and seasonings over a vegetable soup stock base to create any soup, refrigerated/shelf stable soup mix to water, shelf stable alcoholic and non-alcoholic drink mixes

Liquid/Viscous in Top Reservoir Cup Over Solid in Bottom Cup

This product motif includes milk over cereal, microwave ice cream or frozen dessert toppings (butterscotch, fudge, chocolate) on frozen foods, toppings for french fries (e.g. “cheez whiz”; gravies; chili—apply microwave heat), salad dressings for salad, pasta sauce over pasta (apply microwave heat), and milk shake concentrate over ice cubes—blender action creates a cold shake

### Reservoir

The invention involves a reservoir that can be securely mated to a container for the purpose of transferring a food from the reservoir into the container for further preparations. The reservoir typically contains a shape that is configured to cooperate with the container for ease of use. Typically, if the container is an upright cylinder, the reservoir is similarly a cylinder that can securely mate to the container. If the container is triangular, oval, rectangular, square or other geometric shape, the reservoir has a complementary shape providing a secure mating structure. The container typically comprises opposite openable surfaces in the container to permit ease of transfer of a food to the container. In use, a first opening means is removed from a first openable surface, the reservoir is then mated to the container and the food is transferred from the container. Food transfer can be made particularly efficient by providing a second opening means in the container on an opposite surface of the reservoir to the first opening means. The reservoir and the container typically comprise cooperating mating or joining surfaces. These cooperating surfaces often involved one surface that is placed into the second surface to form a sufficiently secure mechanical joint for food transfer. The joint is typically temporary, since in many embodiments of the invention, the reservoir will be removed from the container. In one preferred embodiment of the invention, the joining surfaces include a flange that has an extended portion that surrounds the upper portion of the container. In this embodiment, the extended portion grips and forms a temporary but reliable connection to the container. Once the reservoir, with one opened end, is mounted on the container, the second opening means can be removed from the reservoir to transfer the food from the reservoir to the container. Any food that remains within the reservoir can be mechanically transferred into the container. When using certain foods such as ice cream, frozen soups and stews or other materials the entire portion or a substantial portion will remain within the container even after the first opening is removed. Such foods require often substantial mechanical force to ensure transfer of the solid contents of the reservoir into the container. Other foods such as dried soup mixes, dried breakfast cereals and other particulate materials comprise global solids can be easily transferred without difficulty simply by removing the initial opening. However, by removing the second opening, any remaining food can be readily removed from the reservoir to ensure complete transfer.

The reservoir can be sized and configured for a single serving portion of a combination food. Alternatively, the reservoir can be sized and configured for two, three, four or more individual serving portions that can be made in the appropriately sized mating reservoir.

The reservoir, for many of the combination foods of the invention is typically a prepackaged component that is filled and sealed at a factory location and sold in a retail establishment for combination with a container available at the retail establishment. Typically, the reservoir contains one component of a combination food that can be combined with a second food in the container. The second food is typically a food available at the retail location including, as discussed elsewhere in this disclosure, a liquid food such as coffee, carbonated beverage, a dairy product such as milk or yogurt or other food typically used in combination foods.

In one particularly useful embodiment, the reservoir comprises a substantially cylindrical body having a mating surface complementary with the container. The substantially cylindrical body typically comprises opposing ends, each end having opening means. As described above, each opening mean is used in a different part of a method for making the combination food. In a preferred embodiment, differing opening means are used for the container structures. In one embodiment of the invention, the reservoir comprises a cup-like structure having, in the base of the cup, a score line/pull tab opening means formed in the thermoplastic material of the cup. The opposing end of such a reservoir contains a paper, foil, film or composite closure adhered to a surface proximate the mating surface that provides attachment to the container. In the operation of the invention, the paper, film, foil or other composite closure is first removed from the reservoir and secondarily, the pull tab/score line closure is removed from the cup to ensure complete transfer of the food to the container.

In the manufacture of the reservoir, the score line/pull tab opening means can be formed simultaneously with cup manufacture. The score line/pull tab can be an aspect of the cup that is injection molded with the reservoir manufacture. The reservoir can then be filled with the food product and then closed with the foil, paper, film or other combination closure that is adhered to the opening in the reservoir structure.

### DETAILED DESCRIPTION OF THE DRAWINGS

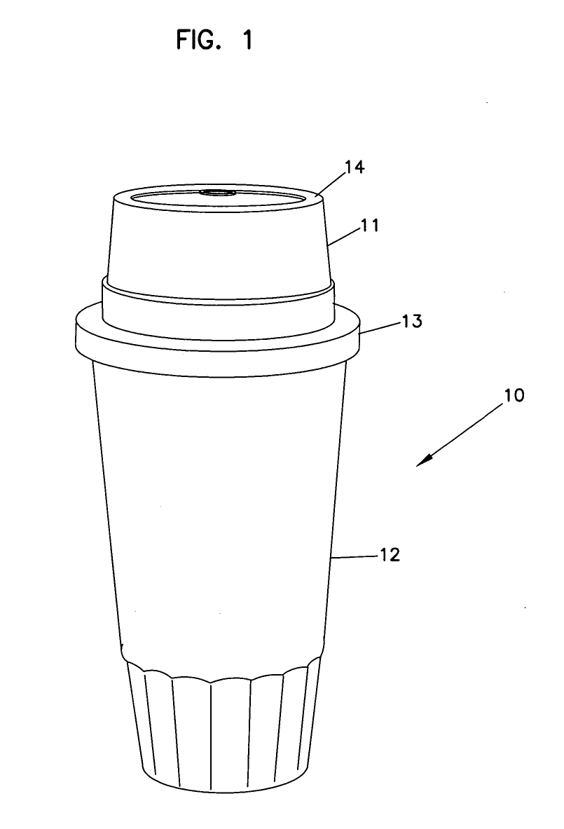

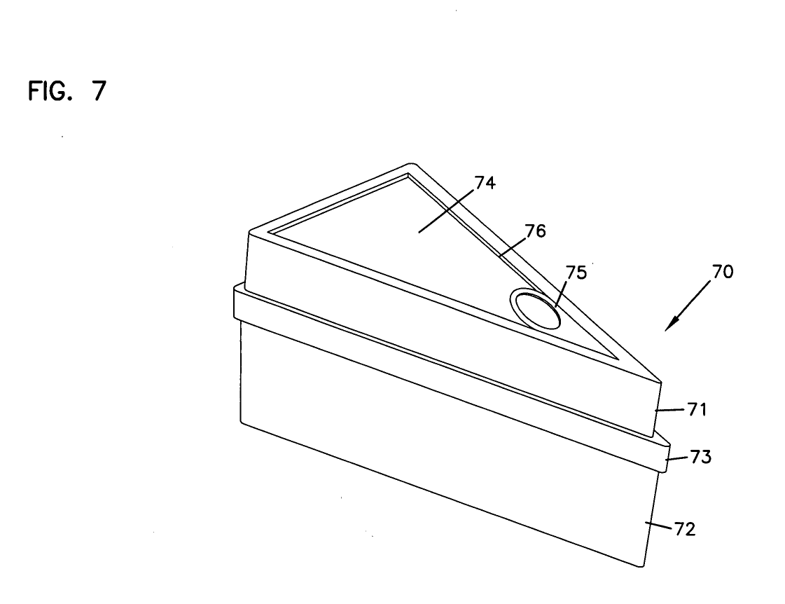

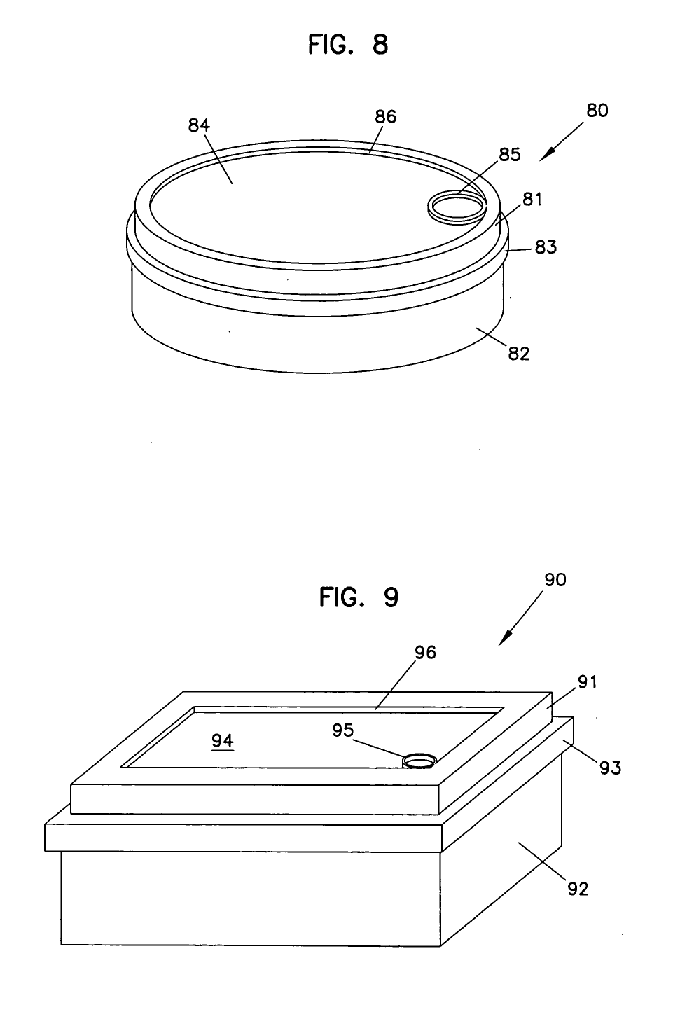

As discussed above, the invention involves a reservoir for a food combined with a container that can receive the food from the reservoir. The reservoir has certain closure embodiments and is configured to be made into the useful structure of the invention. FIGS. 1-6 exemplify a system adapted to an ice cream float system. FIGS. 7-13 exemplify a general system that can be used to transfer a food from a reservoir to a container for combination with a second food to form a combination food.

In this system the ice cream or other frozen dessert is transferred from the reservoir to the container and is then combined with a carbonated beverage or other second food. This system is exemplary in nature and should not be considered as limiting the invention. Using the system as described can combine many foods. In many embodiments, a first food is placed and maintained in the reservoir and stored under a condition that maintains stability or freshness. That first food then can be combined with a second food in the container. Preferably the second food is a food that is dispensed or served fresh in the commercial location such as a carbonated beverage, a soft serve preparation, a coffee or tea, pizza, bakery products, hot dog, hamburger, sandwich, etc. In this way a freshly prepared food can be combined with a food that is stored in a useful manner.

FIG. 1 is a representation of one embodiment of the invention that involves a structure of a reservoir and a mated container. The system 10 comprises a reservoir 11 that comprises a tapered cylindrical structure. The system 10 also comprises a container 12 in the shape of a tapered cylindrical container. The reservoir 11 can be mated with reservoir 12 at a mating means or mating structure 13 that enables the reservoir 11 to be sufficiently securely connected to container 12 to maintain a fit at least during transfer of the food from the reservoir to the container. The reservoir 11 also contains a closure 14 shown at the upper end of the reservoir as depicted in FIG. 1. In this embodiment, the system is configured for the creation of an ice cream float. Reservoir 11 contains a portion of a frozen ice cream or other similar frozen or high viscosity dessert. Once the reservoir 11 is opened and the food (not shown) contained in the reservoir is transferred to container 12, then a carbonated beverage or other similar liquid food can be added to the container, combined with the ice cream producing the combination food, in this instance, an ice cream float.

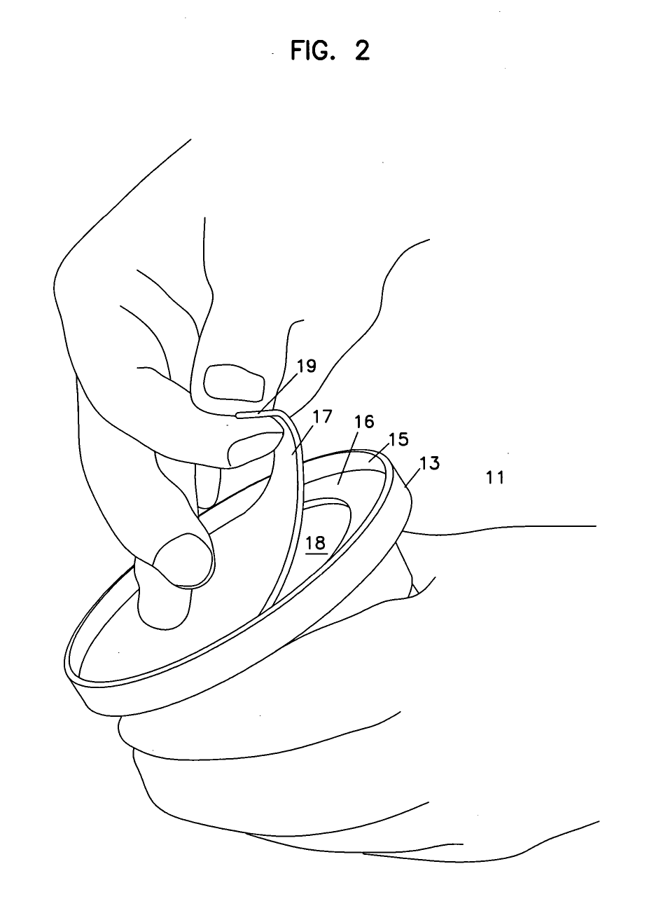

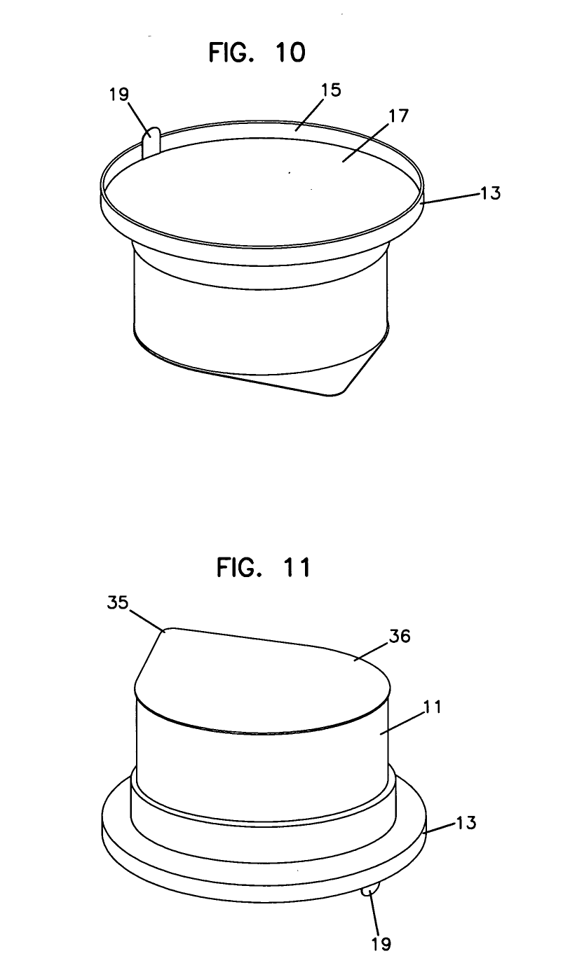

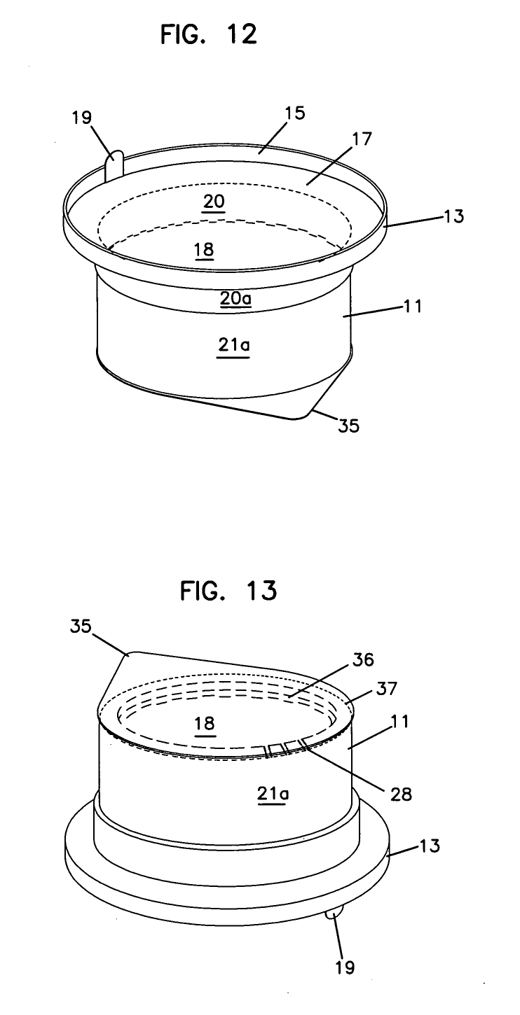

As discussed elsewhere, the reservoir, e.g. reservoir FIGS. 2 and 10-13 can be used to contain a food. The food can comprise a solid or a particulate food and the reservoir can be substantially filled or partly filled. In FIGS. 2 and 10-13 the reservoir typically comprises closure means at opposite ends of the reservoir. The reservoir shown in FIGS. 2 and 10 through 13 with the closure 17 comprising a paperboard, flexible film, paper or foil combination closure is partially removed. The reservoir 11 is filled with food contents 18. The closure 17 is friction fit, press fit or adhered to structures 15 and, if necessary to a closure surface 16, to protect the food from contamination. Alternatively, the closures 17 can be friction fit into the reservoir skirt 15. The closure 17 is removed by grasping tab 19 and manually removing the flexible film, paper or foil closure from the closure surface 16 using minimal force. The reservoir 11 also comprises a mating structure or surface 13 that enables the reservoir to be securely mated or joined to the container 12. In this embodiment, the mating surface comprises a skirt structure 15 of the mating surface that extends over the surface 42 of the container 12 that secures the skirt 15 to the surface 42 of the container 12 using frictional forces resulting in a secure joint. Once such a joint is secure, the food contents 18 can be easily transferred to the container 12. FIGS. 12 and 13 show the structure of the reservoir 11 hidden by the closure means 17 and 36. In FIG. 12, the closure means 17 also containing a tab 19 that can be grasped to remove the closure is shown. Beneath the closure 16, is a closure surface 16 against which the closure 17 is placed. In FIG. 13, the closure 36 can be paperboard, flexible film, paper or foil or combinations thereof and can be adhered to surface 37. Hidden by closure 17 are vertical surfaces 20 and 21 comprising the interior portions of the exterior walls 20a and 21a. Similarly, in FIGS. 11 and 13, the adhered closure 36 having tab 35 is shown adhesively bonded to the end of closure of reservoir 11. FIG. 13 shows the hidden view of the open end of reservoir 11. The open end of reservoir 11 comprises an adhering surface 37, an interior wall portion 39 that is reinforced by reinforcing portions 28 that extend from the exterior wall 21a to the interior wall 39 reinforcing the interior wall and the entire open end.

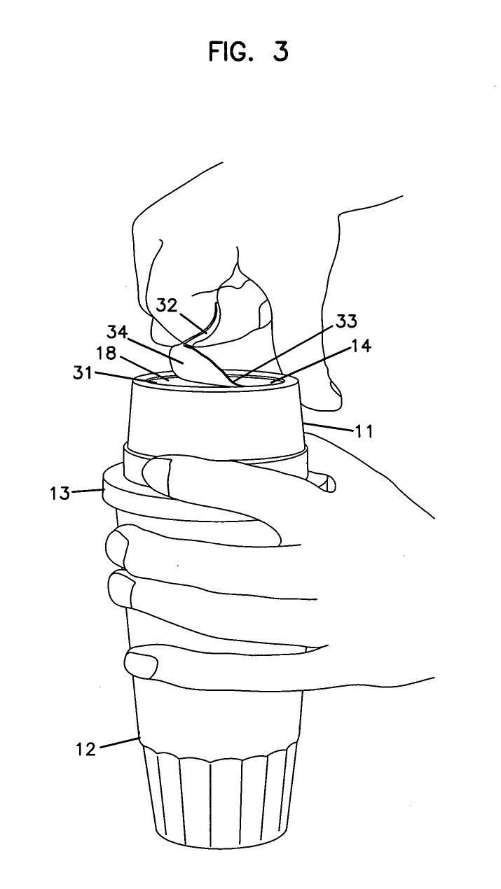

FIGS. 3 and 10 through 13 show the operation of the closures of the reservoir. In this embodiment, closure 14 comprises a portion of the thermoplastic reservoir cup that can be removed by grasping pull-tab 32 and removing the closure 14 along fracture line 33 revealing the food contents 18. Shown in FIG. 3, a consumer has grasped pull-tab 32 and has partially removed removal closure portion 34 from the reservoir 11 along score line 33. Once the removal closure portion 33 is entirely removed from the reservoir 11, the contents of the reservoir, if remaining within the reservoir, can then be removed using minimal force. Alternatively, a film, foil, or paper closure 36, adhered to the reservoir 11 can be removed by grasping tab 35 (FIGS. 11 and 13). During the operation, the consumer maintains the container 12 and reservoir 11 in a stable configuration using mating surface 13 to maintain the combined structure in a secure and stable configuration.

FIG. 4 shows a vertical cross section of FIG. 1. In FIG. 4, reservoir 11 is mated to container 12 at mating surface 13. The container 12 has a rolled edge 41 that forms a secure friction joint with mating surface of reservoir 42 comprising the skirt portion 15. FIG. 4 additionally shows food contents 18 held within reservoir 11. Pull tab 32 is shown prior to grasping by the consumer (not shown), the closure 14 and score line 31. Pull tab 19 used in the closure of FIG. 2 is also shown.

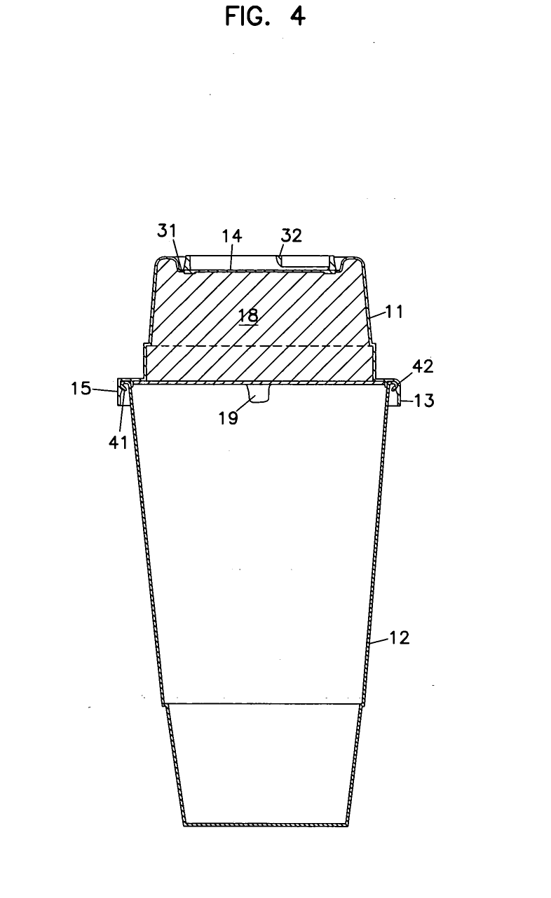

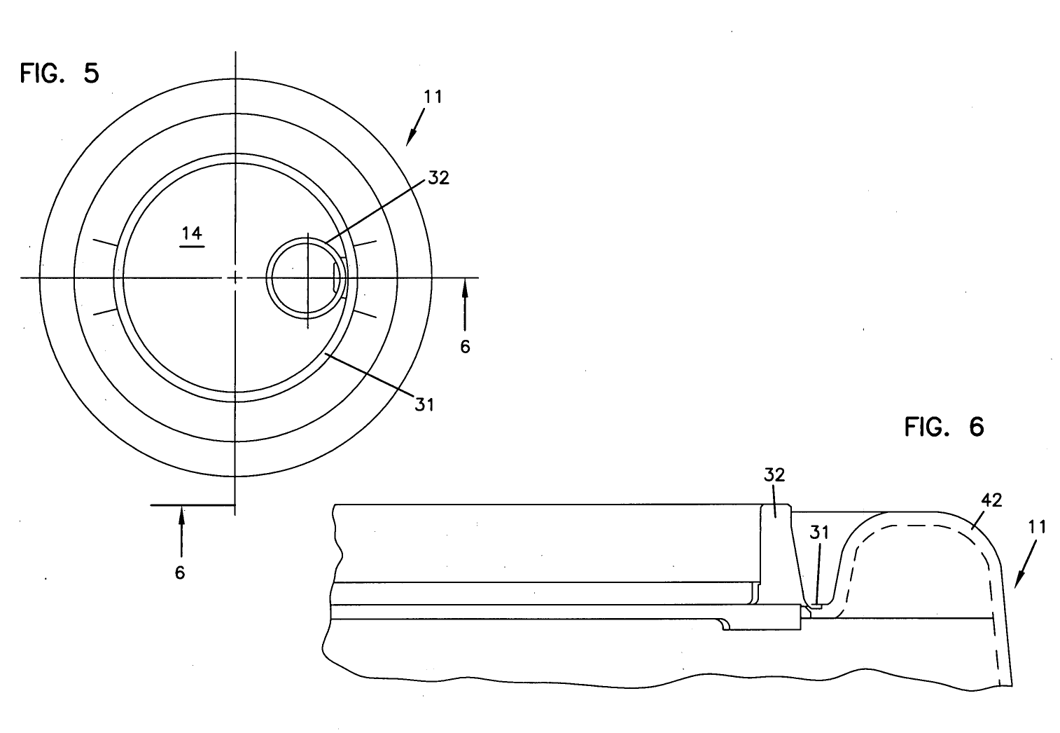

FIG. 5 is a top view of the container of FIG. 1 showing the detail regarding the pull tab/score line closure structure. In FIG. 5, reservoir 11 is shown with closure 14. Closure 14 can be removed by grasping pull tab 32 and applying force to the pull tab causing the closure to fracture along score line 31 to remove the entirety of closure 14.

FIG. 6 is a cross section of a portion of FIG. 5 showing details of the pull tab/score line removal structure. Pull tab 32 is shown adjacent to score line 31, the mating surface of reservoir 42 of FIG. 11.

Lastly, the remaining figures show the use of the system of the invention in various shapes that can be used with different foods systems. FIGS. 7, 8 and 9 show triangular, oval and rectangular embodiments of the invention involving the use of a reservoir and container to add a solid food from the reservoir to a solid food of a container. In FIGS. 7, 8 and 9 the systems 70, 80 and 90 comprises a reservoir 71, 81 and 91 and a container 72, 82 and 92 joined by a mating surface 73, 83 and 93. The reservoir 71, 81 and 91 can contain a flexible film, paper, foil or combination thereof closure on the surface of the reservoir (not shown). The opposing surface of the reservoir 71, 81 or 91 comprises a closure 74, 84 or 94 involving a pull tab 75, 85 or 95 and score line 76, 86 or 96 that permits the consumer to remove a shaped closure portion 74, 84 or 94 from reservoir 71, 81 or 91 permitting the consumer to transfer, e.g., an first food portion (not shown) from reservoir 71, 81 or 91 into the container 72, 82 or 92. The container 72, 82 or 92 can contain a second food such as a bakery item such as a cobbler, pie, cookie or other bakery item that is commonly used in combination with an ice cream component.

The foregoing specification, examples and figures provide a description of the invention as it is currently understood. The invention can have a variety of embodiments and aspects. Accordingly, the invention resides in the claims hereinafter appended.

1. A reservoir for a solid food product comprising a reservoir comprising an interior having a volume of about 20 milliliters to 5 liters, the reservoir comprising opposing open able ends, each end having opening means providing access to the interior, the reservoir additionally comprising means to mate the reservoir with a container; wherein the reservoir is conformed to permit transfer of the food contents from the reservoir to the container.

2. The reservoir of claim 1 wherein the opening means comprises a pull-tab and score line closing an openable end.

3. The reservoir of claim 1 wherein the opening means comprises a flexible film, foil, paper or combination thereof closing an openable end.

4. The reservoir of claim 1 wherein the volume comprises about 100 milliliters to one liter.

5. The reservoir of claim 1 wherein the reservoir comprises a single serving portion of a frozen food product.

6. The reservoir of claim 5 wherein the frozen food product comprises ice cream.

7. The reservoir of claim 1 wherein the reservoir comprises a single serving portion of a breakfast cereal.

8. The reservoir of claim 1 wherein the reservoir comprises a single serving portion dry soup mix.

9. The reservoir of claim 8 wherein the dry soup mix comprises a lyophilized composition.

10. The reservoir of claim 1 wherein the reservoir substantially comprises a thermoplastic enclosure wherein a pull tab/score line opener is integrally molded into an openable end of the reservoir and the opposite end is closed by a flexible paper, foil film or combination thereof adhered to an openable end of the reservoir.

11. The reservoir of claim 1 wherein the mounting means comprises a skirt formed proximate to an opening means that can form a secure joint through frictional forces with a container.

12. The reservoir of claim 11 wherein the reservoir comprises a cylindrical enclosure.

13. The reservoir of claim 11 wherein the reservoir comprises a tapered cylindrical enclosure.

14. The reservoir of claim 11 wherein the enclosure comprises a stepped, tapered cylindrical enclosure.

15. The reservoir of claim 1 comprising a disposable reservoir.

16. The reservoir of claim 1 comprising means to mate comprising an adhesive system.

17. The reservoir of claim 1 comprising a tapered cylinder having a mating flange at the larger end.

18. The reservoir of claim 1 comprising a volume of from about 250 milliliters to about 1 liter.

19. The reservoir of claim 1 comprising volume of 300 milliliters to 2 liters.

20. A method for combining two compatible food materials in a container, the method comprising:
(a) removing a opening means from a reservoir, the reservoir comprising an interior having a food composition, the reservoir additionally comprising a removable portion defined by a score line and pull tab to form an opened container;
(b) contacting a mating surface of the reservoir with the container to form a mated reservoir;
(c) removing the removable portion defined by the score line; and
(d) transferring the food from the open reservoir to the serving container.

21. The method of claim 20 wherein the serving container is an empty container and the food is transferred before the removable portion is removed.

22. The method of claim 21 wherein a second food is added to food in the container.

23. The method of claim 20 wherein the food is a solid food.

24. The method of claim 22 wherein the second food is a solid food.

25. The method of claim 22 wherein both the food and the second food comprises a solid food and the second food is added to the container prior to addition of the first food.

26. The method of claim 20 wherein the food is transferred by applying pressure to the material.

27. The method of claim 20, wherein the food in the reservoir is combined with a freshly prepared food.

28. A system for serving a combination food comprising a container and a reservoir for a food product, the reservoir comprising a contained volume of about 20 milliliters to 5 liters, the reservoir comprising opposing open able ends, each end having opening means providing access to food contents, the reservoir additionally comprising means to mate the reservoir with the container; wherein the reservoir is conformed to permit transfer of the food contents from the reservoir to the container.

29. The system of claim 28 wherein the opening means comprises a pull-tab and score line closing an openable end.

30. The system of claim 28 wherein the opening means comprises a flexible film, foil, paper or combination thereof closing an openable end.

31. The system of claim 28 wherein the reservoir volume comprises about 100 milliliters to one liter and the container comprises a volume of about 50 milliliters to 5 liters.

32. The system of claim 28 wherein the container and the reservoir comprises a single serving portion of a food product.

33. The system of claim 32 wherein the food product comprises ice cream.

34. The system of claim 28 wherein the container and reservoir comprises a single serving portion of a breakfast cereal.

35. The system of claim 28 wherein the container and reservoir comprises a single serving portion dry soup mix.

36. The system of claim 28 wherein the food in the reservoir is combined with a freshly prepared food.

37. The system of claim 28 wherein the reservoir substantially comprises a thermoplastic enclosure wherein a pull tab/score line opener is integrally molded into an openable end of the reservoir and the opposite end is closed by a flexible paper, foil film or combination thereof adhered to an openable end of the reservoir.

38. The system of claim 28 wherein the mounting means comprises a skirt formed proximate to an opening means that can form a secure joint through frictional forces with a container.

39. The system of claim 38 wherein the reservoir comprises a cylindrical enclosure.

40. The system of claim 38 wherein the reservoir comprises a tapered cylindrical enclosure.

41. The system of claim 38 wherein the enclosure comprises a stepped and tapered cylindrical enclosure.

42. An ice cream float preparation system comprising a sealed reservoir comprising means to mate to a container, the sealed reservoir comprising a substantially cylindrical body having a closure at each of two opposing ends and containing about 250 milliliters to 2 liters of a frozen ice cream.

43. A method for combining two compatible food materials, the method comprising:
(a) removing a opening means from a reservoir, the reservoir comprising a volume having a food composition, the container additionally comprising a removable portion defined by a score line and pull tab to form an opened container;
(b) contacting a mating surface of the reservoir to a container to form a mated reservoir;
(c) removing the removable portion defined by the score line; and
(d) transferring the food from the open container to the container.

44. The method of claim 43 wherein the serving container is an empty container and the food is transferred before the removable portion is removed.

45. The method of claim 44 wherein a second food is added to food in the container.

46. The method of claim 43 wherein the food is a solid food.

47. The method of claim 45 wherein the second food is a liquid food.

48. The method of claim 45 wherein both the food and the second food comprises a solid food.

49. A method for combining ice cream with a carbonated beverage, the method comprising:
(a) removing an opening means from a ice cream reservoir, the reservoir comprising a single serving portion, the container additionally comprising a removable portion defined by a score line and pull tab to form an opened container;
(b) contacting a mating surface of the reservoir to a carbonated beverage container to form a mated reservoir;
(c) removing the removable portion defined by the score line; and
(d) combining the ice cream with the beverage in the container.

50. The method of claim 43 wherein the serving container is an empty container and the food is transferred before the beverage is added to the container.

51. The method of claim 43 wherein the serving container is an empty container and the food is transferred after the beverage is added to the container.
